(19) United States
(12) Patent Application Publication
(10) Pub. No.: US 2011/0304733 A1
(43) Pub. Date: Dec. 15, 2011

(54) Acident prevention camera

(76) Inventor: Godwin G. Umoh, Bronx, NY (US)

(21) Appl. No.: 13/134,365

(22) Filed: Jun. 6, 2011

Related U.S. Application Data
(60) Provisional application No. 61/396,901, filed on Jun. 4, 2010.

(51) Int. Cl. H04N 7/18

(52) U.S. Cl. 348/148; 348/E07.085

(57) ABSTRACT

The Accident Prevention Camera records digitized video images by means of a video recording system for automotive vehicles that comprises a closed circuit recording system comprised of four integrated video cameras, a digital recording unit, a video monitor, GPS tracker, and interconnecting wiring. The cameras are strategically mounted at selected positions on a vehicle which affords optimal coverage of the area in front and rear sides of a vehicle. The video images captured by the camera and recorded on the digital recording unit provide comprehensive video proof which is used to determine if a driver was at fault, or not, in the event of an accident. The Accident Prevention Camera employs the use of highly sophisticated equipment integrated with software that enables the system to record everything that happens from four different digital cameras, situated on each side of the vehicle.

### CLAIM OF PRIORITY

This patent application claims priority under 35 USC 119 (e) (1) from U.S. Provisional Patent Application Ser. No. 61/396,901 filed Jun. 4, 2010, of common inventorship herewith entitled, “Accident Prevention Camera.”

### FIELD OF THE INVENTION

The present invention pertains to the field of automotive security devices, and more specifically to the field of automotive video recording devices.

### BACKGROUND OF THE INVENTION

The prior art has put forth several designs for automotive video recording devices. Among these are:

U.S. Pat. No. 6,650,359 to Hayle Park describes a system for acquiring and recoding audio, visual and other information, relating to the condition or environment of a motor vehicle, and for storing the information at the vehicle for playback and analysis.

U.S. Pat. No. 7,397,496 to Kenneth E. Arant describes a total perimeter view auto security monitoring system which includes a pair of fixed viewing lenses at each corner of a vehicle, a central digital camera receiving optical data from all corners of the vehicle, a multiplexer to separate the data channels in real time, and a hard disc drive for recording the data.

U.S. Pat. No. 7,493,202 to James C. Demro describes an image processing system adapted to image an area around a vehicle which includes an image processor adapted to receive information indicative of an image of an area proximate to the vehicle automatically captured by an image capturing device. This image processing system can be utilized for crash prevention and crash recording.

None of these prior art references describe the present invention.

### SUMMARY OF THE INVENTION

It is an object of the present invention to provide an automotive video recording device.

### BRIEF DESCRIPTION OF THE DRAWINGS

FIG. 1 is an elevational angled perspective view of the device of the present invention.

FIG. 2 is a close-up rear angled perspective view of a portion of the device of the present invention.

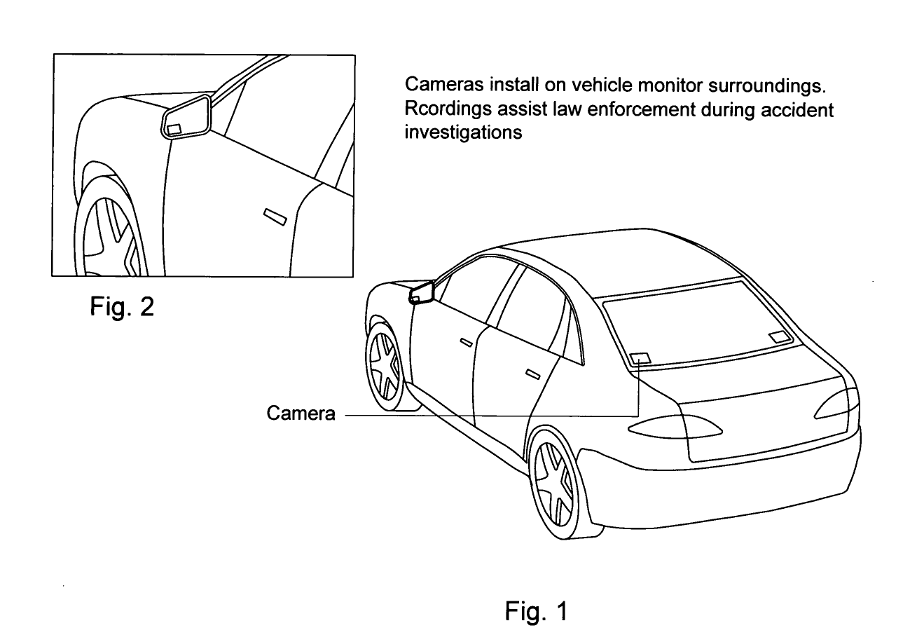

### DETAILED DESCRIPTION OF THE INVENTION

Vehicle accident rates, injuries, and fatalities have declined significantly in rural and urban areas over the last few decades. This is partly due to changes in driving habits, such as increased use of seat belts, the decline in drunken driving, and the improvement in highway and road design and vehicle design. The interstate highway system is the safest type of highway with the lowest accident rates. Vehicular accidents on highways have also declined on both arterial and collector roads, especially in rural areas. The rate of decline in vehicular accidents has, however, been much slower in urban areas. Some accidents result from errors by both drivers involved but, usually, only one driver committed the error which caused the accident although guilt is sometimes hard to prove. Resultantly, accidents occur in which both drivers involved contend that the other driver was at fault, an issue which is only settled after an accident investigation is complete. With the certainty that accidents continue to occur as long as humans drive automotive vehicles, a genuine need exists for an apparatus or system that records visual evidence that conclusively proves if the driver of a vehicle is at fault when an accident occurs. This type of system eliminates the contentious arguments that arise between drivers and ensures that the guilty party is held responsible and greatly facilitates the accident investigation process. This, in turn, greatly alleviates or eliminates the problem experienced by medical providers of not receiving any payment for services rendered until the accident investigation is complete.

The present invention, hereinafter referred as the Accident Prevention Camera, helps curb the number of questionable personal injury lawsuits. With cars getting safer, bodily-injury rates should have dropped dramatically in the last decade. Instead, the rate of bodily-injury claims rose 15 percent. It is worth noting that the National Center for State Courts says that of the approximately 10 million tort filings each year, 42 percent are auto accident cases. The Accident Prevention Camera records digitized video images that are used to speed up the process of determining the guilty party in an auto accident. The Accident Prevention Camera also combats the growing accident fraud problem, a problem which includes thousands of staged or phony auto accidents from organized rings and individuals. Nationally, fraud costs insurers and consumers about $80 billion a year and a major portion of that amount is attributable to claims resulting from staged accidents.

The Accident Prevention Camera is a video recording system for automotive vehicles that comprises a closed circuit recording system. The Accident Prevention Camera is comprised of four integrated video cameras, a digital recording unit, a video monitor, GPS tracker, and interconnecting wiring. The cameras are strategically mounted at selected positions on a vehicle which affords optimal coverage of the area in front and rear sides of a vehicle. The video images captured by the camera and recorded on the digital recording unit provide comprehensive video proof which is used to determine if a driver was at fault, or not, in the event of an accident.

The Accident Prevention Camera employs the use of highly sophisticated equipment integrated with software that enables the system to record everything that happens from four different digital cameras, situated on each side of the vehicle. The recording is done on the digital recording device and stores images from each camera individually. Multiple digital recording devices are merged and fed into a single monitor, which is coupled with the navigational system and the audio-system. The recording cameras, powered by the automotive battery, show the driver the images in motion from all sides of the vehicle. The driver is able to see on the monitor the four individual sides of his car diagonally displayed at the corners of the screen from the small center of the screen which has the date and time, front, rear, left and right images including all objects on the road.

In an alternative embodiment, the device may incorporate an electronic speedometer, to enable additional information regarding the speed of the vehicle at the time of an accident.

Once the police removes the recording device, they take a “police recording” with them from the scene. Once the police views the “police recordings” they issue, via mail, the police report to whoever is interested in the information. The owner of the vehicle communicates with a doctor and an attorney, if needed. The police, insurance companies, doctors and attorneys request copies of the images of the car accident from the police precinct at an additional fee and view them using the special players, which they purchased, and communicate with each other, or duplicate the images, if needed. This technology improves the trust between the professionals, objectively documents the accident and injuries, eliminates involvement from the unnecessary parties and frees their time, lowers the car accident crime rate, enables faster claim settlement and, as a result, makes driving much safer and greatly improves the quality of service to the consumer in the insurance market. Moreover, the Accident Prevention Camera proves an effective detriment to crimes against motorists, such as carjackings, shootings, and other assaults. Seeing a vehicle adorned with sophisticated camera equipment, would-be carjackers, muggers, rapists, and virtually any other ne'er-do-well certainly think twice about victimizing this motorist. Improving vehicular safety as well as offering invaluable documentation, the Accident Prevention Camera is well received by the owners and operators of motor vehicles, as well as automotive manufacturers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An automotive video recording device, consisting of a video recording system for automotive vehicles including a closed circuit recording system comprising four integrated video cameras, a digital recording unit, a video monitor, GPS tracker, and interconnecting wiring, wherein the cameras are strategically mounted at selected positions on a vehicle to provide optimal coverage of the area in front and rear sides of a vehicle, and wherein the video images captured by the camera and recorded on the digital recording unit provide comprehensive video proof which is used to determine if a driver was at fault, or not, in the event of an accident.

2. The device of claim 1 further comprising highly sophisticated equipment integrated with software that enables the system to record everything that happens from four different digital cameras, situated on each side of the vehicle, wherein the recording is done on the digital recording device and stores images from each camera individually; and wherein multiple digital recording devices are merged and fed into a single monitor, which is coupled with the navigational system and the audio-system.

3. The device of claim 2 wherein the recording cameras are powered by the automotive battery, and show the driver the images in motion from all sides of the vehicle and wherein the driver is able to see on the monitor the four individual sides of his car diagonally displayed at the corners of the screen from the small center of the screen which has the date and time, front, rear, left and right images including all objects on the road.

4. The device of claim 2 further incorporating an electronic speedometer to record the speed of a vehicle at the time of an accident.

5. A method of examining the events of an accident wherein the police removes the recording device, they take a copy of the images referred to as a “police recording” with them from the scene; and wherein once the police views the “police recordings” they issue, by mail, the police report to whoever is interested in the information.

6. The method of claim 5 wherein the owner of the vehicle communicates with a doctor and an attorney, and the police, insurance companies, doctors and attorneys request copies of the images of the car accident from the police precinct at an additional fee and view them using the special players, which they purchased, and communicate with each other, or duplicate the images.
